(19) United States
(12) Patent Application Publication
(10) Pub. No.: US 2023/0237389 A1
(43) Pub. Date: Jul. 27, 2023

(54) OPTIMIZATION METHOD, OPTIMIZATION APPARATUS AND PROGRAM

(71) Applicant: NIPPON TELEGRAPH AND TELEPHONE CORPORATION, Tokyo (JP)

(72) Inventors: Yuya HIKIMA, Tokyo (JP); Masahiro KOJIMA, Tokyo (JP); Yasunori AKAGI, Tokyo (JP); Takeshi KURASHIMA, Tokyo (JP); Hiroyuki TODA, Tokyo (JP)

(21) Appl. No.: 18/004,958

(22) PCT Filed: Aug. 4, 2020
(86) PCT No.: PCT/JP2020/029861

§ 371 Date: Jan. 10, 2023

(51) Int. Cl. G06Q 10/04; G06Q 30/0201

(52) U.S. Cl. CPC G06Q 10/04; G06Q 30/0206; G06Q 50/01

(57) ABSTRACT

An optimization method according to one embodiment which is executed by a computer, the method including: an input procedure of inputting an acceptance probability function indicating a probability that each participant participating in a crowdsourcing market will accept a price, and a matching value indicating a value when each resource in the crowdsourcing market is allocated to each participant; a formulation procedure of formulating a first optimization problem for determining an optimal price that maximizes a profit of a provider of the crowdsourcing market using the acceptance probability function and the matching value; and an optimization procedure of calculating the optimal price by solving the first optimization problem according to a feature of the acceptance probability function.

### TECHNICAL FIELD

The present invention relates to an optimization method, an optimization apparatus, and a program.

### BACKGROUND ART

In recent years, with the spread of information technology, various crowdsourcing markets have been constructed. Examples of crowdsourcing markets include a platform for allocating specific tasks to an unspecified number of workers via the Internet, a platform for matching taxi drivers located in space with orderers, and the like.

There are crowdsourcing markets that provide services in a variety of processes, and as one of them, there is a crowdsourcing market that provides a service in a process in which (a) in a situation where a certain number of tasks or workers exist, (b) a service provider determines a price of the corresponding worker or task, and (c) the task or worker is allocated to an object to which the price has been accepted. Examples of the service provided by such a process include a matching service between a taxi driver and an orderer (requester), a crowdsourcing service in the form of allocating tasks at once after gathering workers, and the like. Note that the service provider is a provider of the platform.

Meanwhile, studies on determination of rewards and fees to be imposed on participants in the crowdsourcing market have been conventionally conducted. For example, as an existing study for determining the price of crowdsourcing under the same or similar problem settings as (a) to (c) described above, there is one described in Non Patent Literature 1 or Non Patent Literature 2. In these existing studies, after formulation into an optimization problem, an optimal price is determined by solving the optimization problem.

### CITATION LIST

### Non Patent Literature

Non Patent Literature 1: Haipeng Chen, Yan Jiao, Zhiwei Qin, Xiaocheng Tang, Hao Li, Bo An, Hongtu Zhu, and Jieping Ye. Inbede: Integrating contextual bandit with td learning for joint pricing and dispatch of ride-hailing platforms. In ICDM, pp. 61-70, 2019.
Non Patent Literature 2: Yongxin Tong, Libin Wang, Zimu Zhou, Lei Chen, Bowen Du, and Jieping Ye. Dynamic pricing in spatial crowdsourcing: A matching-based approach. In SIGMOD, pp. 773-788, 2018.

### SUMMARY OF INVENTION

### Technical Problem

However, in Non Patent Literature 1 and Non Patent Literature 2 described above, two requirements of (1) that the value of each matching can be captured as a continuous value, and (2) that the demand and the supply are matched are not satisfied. For this reason, in some cases, the profit of the service provider is lowered.

For example, in Non Patent Literature 2 described above, only whether or not each worker and task can be matched is considered. In other words, the value of each matching is captured as 0 or 1 indicating whether or not matching is possible. However, in practice, it is known that each worker has tasks that he/she is good at and there are workers that are compatible with each task, and it is conceivable that the quality of the achieved task and the degree of satisfaction of the workers could be improved by capturing the value of matching with a continuous value indicating the degree of these types of compatibility.

Furthermore, for example, in Non Patent Literature 1 described above, the price is determined for each task without considering the situation of the worker corresponding to the task. For this reason, in some cases, mismatching occurs between the supply and demand for the workers and the tasks. For example, assume that there are a German translation task of translating Japanese material into German and an English translation task of translating Japanese material into English in a crowdsourcing market. In addition, assume that there are more workers who are English speakers than workers who are German speakers in the crowdsourcing market. At this time, if the price is set without considering the number of workers for these tasks, there is a likelihood that the number of German translation tasks may be gathered in excess of the number of tasks that can be achieved by German-speaking workers, and the number of English translation tasks may be insufficient for English-speaking workers. Conversely, it is conceivable that it is possible to set a price at which the demand and the supply match by considering the balance between the demand and the supply.

Furthermore, in Non Patent Literature 1 and Non Patent Literature 2 described above, approximate solutions to formulated optimization problems have been proposed, but the approximation rate of the solution is not guaranteed by a certain constant. For this reason, in a specific situation, there is a likelihood that the accuracy of the solution would be impaired, and the price would be set such that the profit of the service provider is impaired.

An embodiment of the present invention has been made in view of the above points, and an object thereof is to determine an optimal price in consideration of a matching value and a supply and demand balance in a crowdsourcing market.

### Solution to Problem

In order to achieve the above object, there is provided an optimization method according to one embodiment which is executed by a computer, the method including: an input procedure of inputting an acceptance probability function indicating a probability that each participant participating in a crowdsourcing market will accept a price, and a matching value indicating a value when each resource in the crowdsourcing market is allocated to each participant; a formulation procedure of formulating a first optimization problem for determining an optimal price that maximizes a profit of a provider of the crowdsourcing market using the acceptance probability function and the matching value; and an optimization procedure of calculating the optimal price by solving the first optimization problem according to a feature of the acceptance probability function.

### Advantageous Effects of Invention

An optimal price can be determined in consideration of a matching value and a supply and demand balance in a crowdsourcing market.

### BRIEF DESCRIPTION OF DRAWINGS

FIG. 1 is a diagram illustrating an example of a value when allocating a resource to a participant.

FIG. 2 is a diagram illustrating an example of a minimum convex secondary cost flow problem.

FIG. 3 is a diagram illustrating an example of a minimum convex cost flow problem.

FIG. 4 is a diagram illustrating an example of a functional configuration of a price optimization apparatus according to the present embodiment.

FIG. 5 is a flowchart illustrating an example of a flow of price optimization processing according to the present embodiment.

FIG. 6 is a flowchart illustrating an example of a flow of solution calculation processing of optimization problems according to the present embodiment.

FIG. 7 is a diagram illustrating an example of a hardware configuration of the price optimization apparatus according to the present embodiment.

### DESCRIPTION OF EMBODIMENTS

Hereinafter, one embodiment of the present invention will be described. In the present embodiment, a crowdsourcing market is assumed that provides a service in a process in which (a) in a situation where a certain number of tasks or workers exist, (b) a service provider determines a price of the corresponding worker or task, and (c) the task or worker is allocated to an object to which the price has been accepted, and a price optimization apparatus 10 will be described that is capable of calculating an optimal price in consideration of a matching value and a supply and demand balance in this crowdsourcing market.

### Theoretical Configuration of Present Embodiment

A theoretical configuration when calculating the optimal price in consideration of the matching value and the supply and demand balance by the price optimization apparatus 10 according to the present embodiment will be described.

<<Formulation of Problem of Maximizing Profit of Service Provider>>

It is assumed that there are two sides in the crowdsourcing market assumed in the present embodiment. A situation is considered where there is a limited number of resources on one side and participants on the other side participate in response to the price. For example, a crowdsourcing platform in which a translation task (participant) emerges in response to a fee set in a situation where a certain number of workers (resources) exist in the market, a taxi-hailing platform in which an orderer (participant) emerges in response to a fee set for each taxi driver while a certain number of taxi drivers (resources) are working in town, and the like correspond to the crowdsourcing market corresponding to the above situation.

In the present embodiment, it is assumed that the number of participants in the crowdsourcing market is n, and there are m limited resources. At this time, it is assumed that i=1, 2, . . . , n represents an index of each participant, and j=1, 2, . . . , m represents an index of each resource. Each participant i has an acceptance probability Sᵢ(x) for a price x. The acceptance probability Sᵢ(x) is a function representing the probability of accepting the price x when the price x is presented to the participant i, and the amount of demand is stochastically determined by the function. For example, in a crowdsourcing platform in which workers and tasks are resources and participants, respectively, or a taxi-hailing platform in which taxi drivers and orderers are resources and participants, respectively, the acceptance probability Sᵢ(x) is generally higher when the price x is lower, and the acceptance probability Sᵢ(x) is lower when the price x is higher.

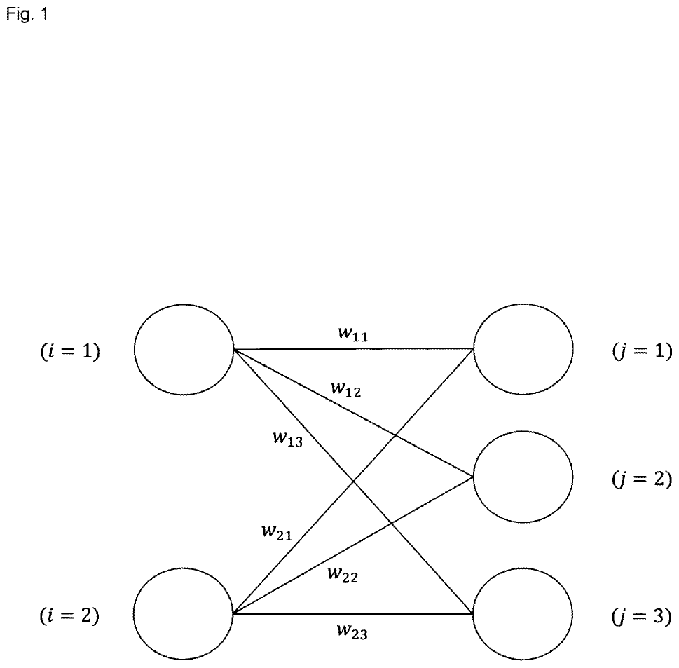

In addition, there is a positive or negative value (that is, a matching value) in allocating a resource j to a participant i, which is represented by wᵢⱼ∈R (where R is a set of all real numbers). Note that the value wᵢⱼ is a continuous value indicating a degree or the like of compatibility of the participant i and the resource j, and examples thereof include a degree indicating how good the worker j is at the translation task i, a value indicating how far the current location of the taxi driver j is away from the current location of the orderer i, and the like. As an example, in a case of n=2 and m=3, a value wᵢⱼ when allocating the resource j to the participant i is illustrated in FIG. 1. As illustrated in FIG. 1, there is a value wᵢⱼ when allocating each resource j to each participant i.

In addition, a vector having a price pᵢ∈R presented to each participant i as the i-th element is referred to as a price vector, and denoted as p∈Rⁿ. At this time, it is assumed that the service provider maximizes the profit by solving an optimization problem shown in Expression (1) below.

$$\begin{matrix}[ Math . 1 ] & \\ \begin{matrix}{max}_{z} & ( {p}_{i} + {w}_{ij} ) \cdot {z}_{ij} \\ s . t . & {\sum }_{j} {z}_{ij} \leq {a}_{1} ( i = 1 , 2 , … , n ) \\ & {\sum }_{i} {z}_{i j} \leq 1 ( j = 1 , 2 , … , m ) \\ & {z}_{ij} ∈ \{ 0 , 1 \} ( i = 1 , 2 , … , n , j = 1 , 2 , … , m )\end{matrix} & ( 1 )\end{matrix}$$

where a∈{0, 1}ⁿ is a vector indicating acceptance or non-acceptance of each participant, and the i-th element is aᵢ. If aᵢ=1, it represents that the participant i accepts the price pᵢ, or if aᵢ=0, it represents that the participant i rejects the price pᵢ. Furthermore, zᵢⱼ represents whether or not to allocate the resource j to the participant i; if zᵢⱼ=1, it represents that the allocation is performed, or if zᵢⱼ=0, it represents that the allocation is not performed.

Since the price pᵢ represents the amount of money (here, if negative, the amount paid to the participant i) that the service provider collects from the participant i, and wᵢⱼ represents the value when the resource j is allocated to the participant i, (pᵢ+wᵢⱼ) in the objective function of the optimization problem shown in Expression (1) above represents the profit when the resource j is allocated to the participant i. Note that the case where the price pᵢ is negative corresponds to, for example, a case where the participant side is a worker and the service provider pays the worker side a salary.

In addition, the first constraint condition is a constraint to allocate resources only to a participant who has accepted the price, and the second constraint condition is a constraint to allocate only one resource (that is, a constraint that prevents one resource from being allocated to a plurality of participants).

At this time, in the present embodiment, solving an optimization problem shown in Expression (2) below will be considered.

$$\begin{matrix}[ Math . 2 ] & \\ {max}_{p} {𝔼}_{a ∼ Pr ( \cdot \vert p )} [ f ( p , a ) ] s . t . p ∈ {ℝ}^{n} & ( 2 )\end{matrix}$$

$$where$$

$$\begin{matrix}[ Math . 3 ] & \\ Pr ( a \vert p ) := {\prod }_{i = 1}^{n} \{ {{S}_{i} ( {p}_{i} )}^{{a}_{i}} {( 1 - {S}_{i} ( {p}_{i} ) )}^{( 1 - {a}_{i} )} \} & \end{matrix}$$

In addition, f(p, a) represents an optimal value of the optimization problem shown in Expression (1) under a and p, i.e., the profit of the service provider. That is, the optimization problem shown in Expression (2) above is a problem of obtaining p that maximizes the expected value (expected profit) of the profit f(p, a) when sampling a according to the probability Pr(·|p). Note that the optimization problem shown in Expression (2) above includes the optimization problem formulated in Non Patent Literature 2 described above.

<<Solution of Optimization Problem Shown in Expression (2)>>

By solving the optimization problem shown in Expression (2) above, it is possible to calculate and determine an optimal price. Any optimization method may be used as long as an optimal solution or an approximate solution of the optimization problem shown in Expression (2) can be derived. For example, a solution may be obtained by a genetic algorithm, Bayesian optimization, or the like, or a newly proposed algorithm or the like may be used in the future.

However, since there is no conventional method capable of solving the optimization problem shown in Expression (2) above at high speed at present, an approximate solution is proposed below. Note that since the optimization problem shown in Expression (2) above includes the optimization problem formulated in Non Patent Literature 2 described above, the approximate solution proposed below can also be applied to the optimization problem formulated in Non Patent Literature 2.

The approximate solution proposed in the present embodiment branches into any of procedures 1-2a, 1-2b, and 1-2c according to the feature of the acceptance probability Sᵢ after completing a common procedure 1-1.

Procedure 1-1: Approximation of Objective Functions E_{a to Pr(·|p)} [f(p, a)]

In order to obtain an approximate value of the objective functions E_{a to Pr(·|p)} [f(p, a)] of the optimization problem shown in Expression (2) above, an optimization problem shown in Expression (3) below is considered.

$$\begin{matrix}[ Math . 4 ] & \\ \begin{matrix}{max}_{z} & ( {p}_{i} + {w}_{i j} ) \cdot {z}_{i j} \\ s . t . & {\sum }_{j} {z}_{ij} \leq {S}_{i} ( {p}_{i} ) ( i = 1 , 2 , … , n ) \\ & {\sum }_{i} {z}_{i j} \leq 1 ( j = 1 , 2 , … , m ) \\ & {z}_{i j} ∈ \{ 0 , 1 \} ( i = 1 , 2 , … , n , j = 1 , 2 , … , m )\end{matrix} & ( 3 )\end{matrix}$$

Denoting the optimal value for a specific p of the optimization problem shown in Expression (3) as follows:

\hat{f}(p) [Math. 5]

$$\begin{matrix}[ Math . 6 ] & \\ \frac{1}{3} \cdot \hat{f} ( p ) \leq {𝔼}_{a ∼ Pr ( \cdot \vert p )} [ f ( p , a ) ] \leq \hat{f} ( p ) & \end{matrix}$$

is satisfied for any p. Note that hereinafter, in the text of the specification, the optimal value for a specific p of the optimization problem shown in Expression (3) above is denoted as “\hat{ }f(p)”.

In a case where \hat{ }f(p) is used as E_{a to Pr(·|p)} [f(p, a)], the optimization problem shown in Expression (2) above is formulated as in the following Expression (4):

$$\begin{matrix}[ Math . 7 ] & \\ \begin{matrix}{max}_{p , z} & ( {p}_{i} + {w}_{ij} ) \cdot {z}_{ij} \\ s . t . & {\sum }_{j} {z}_{i j} \leq {S}_{1} ( {p}_{i} ) ( i = 1 , 2 , … , n ) \\ & {\sum }_{j} {z}_{i j} \leq 1 ( j = 1 , 2 , … , m ) \\ & 0 \leq {z}_{ij} \leq 1 ( i = 1 , 2 , … , n , j = 1 , 2 , … , m )\end{matrix} & ( 4 )\end{matrix}$$

$$For any p ,$$

$$\begin{matrix}[ Math . 8 ] & \\ \frac{1}{3} \cdot \hat{f} ( p ) \leq {𝔼}_{a ∼ Pr ( \cdot \vert p )} [ f ( p , a ) ] \leq \hat{f} ( p ) & \end{matrix}$$

is satisfied. Therefore, it can be shown that an optimal solution p* obtained by solving the optimization problem shown in Expression (4) above is an approximate solution in which a degree of approximation of 3 is guaranteed for the optimization problem shown in Expression (2) above. That is, it can be shown that the ratio between the optimal solution of the optimization problem shown in Expression (4) above and the optimal solution of the optimization problem shown in Expression (2) above is 3 or less.

Therefore, in the following, it is considered to solve the optimization problem shown in Expression (4) above at high speed according to the feature of the acceptance probability Sᵢ to obtain an approximate solution.

Procedure 1-2a: Solution of Optimization Problem Shown in Expression (4) in a Case where the Acceptance Probability Sᵢ is Represented by a Linear Function with Upper and Lower Limits

It is assumed that the acceptance probability Sᵢ(x) is a continuous function that can be expressed as follows:

$$\begin{matrix}[ Math . 9 ] & \\ {S}_{i} ( x ) = \{ \begin{matrix}{L}_{i} & ( x > {p}_{i}^{u} ) \\ - {c}_{i} \cdot x + {d}_{i} & ( {p}_{i}^{k} \leq x \leq {p}_{i}^{u} ) \\ 0 & ( x < {p}_{i}^{u} )\end{matrix} & \end{matrix}$$

using certain Lᵢ, cᵢ, dᵢ, pᵢ^{k}, and pᵢ^{u}. Here, cᵢ is positive. In addition, it is assumed that a vector having pᵢ^{k} as the i-th element is p^{k}, and a vector having pᵢ^{u} as the i-th element is p^{u}.

At this time, it can be shown that there is an optimal solution p* that satisfies p^{k}≤p*≤p^{u}, and in addition, satisfies the equality under the first constraint condition (that is, for i=1, 2, . . . , n, the constraint condition that the sum of zᵢⱼ for all j is equal to or less than Sᵢ(pᵢ)) for all i among the optimal solutions of the optimization problem shown in Expression (4) above. Therefore, the optimization problem shown in Expression (4) above is equivalent to the following optimization problem:

$$\begin{matrix}[ Math . 10 ] & \\ \begin{matrix}{max}_{p , z} & {\sum }_{i} ( - \frac{1}{{c}_{i}} . {( {\sum }_{j} {z}_{ij} )}^{2} + \frac{{d}_{i}}{{c}_{i}} \cdot {\sum }_{j} {z}_{ij} ) + {\sum }_{ij} {w}_{ij} \cdot {z}_{ij} \\ s . t . & {\sum }_{j} {z}_{ij} = - {c}_{i} \cdot {p}_{i} + {d}_{i} ( i = 1 , 2 , … , n ) \\ & {\sum }_{i} {z}_{ij} \leq 1 ( j = 1 , 2 , … , m ) \\ & 0 \leq {z}_{i j} \leq 1 ( i = 1 , 2 , … , n , j = 1 , 2 , … , m ) \\ & {p}^{k} \leq p \leq {p}^{u}\end{matrix} & \end{matrix}$$

Here, p is deleted from the objective function by substituting the equation of the first constraint condition of the optimization problem shown in Expression (4) above.

At this time, new subscripts s and t are prepared. It is assumed that for all i, zₛᵢ:=Σⱼzᵢⱼ, and for all j, zⱼₜ:=Σᵢzᵢⱼ. In addition, when zₛₜ is provided as a slack variable, the above optimization problem can be rewritten as the following Expression (5):

$$\begin{matrix}[ Math . 11 ] & \\ \begin{matrix}{max}_{z} & {\sum }_{i} ( \frac{1}{{c}_{i}} \cdot {z}_{si}^{2} - \frac{{d}_{i}}{{c}_{i}} {z}_{si} ) - {\sum }_{ij} {w}_{ij} \cdot {z}_{ij} \\ s . t . & {\sum }_{i} {z}_{si} + {z}_{st} = n , {\sum }_{j} {z}_{jt} + {z}_{st} = n \\ & {z}_{si} - {\sum }_{j} {z}_{ij} = 0 ( i = 1 , 2 , … , n ) \\ & {\sum }_{i} {z}_{ij} - {z}_{j t} = 0 ( j = 1 , 2 , … , m ) \\ & 0 \leq {z}_{si} \leq {L}_{i} ( i = 1 , 2 , … , n ) \\ & 0 \leq {z}_{j t} \leq 1 ( j = 1 , 2 , … , m ) \\ & 0 \leq {z}_{ij} \leq 1 ( i = 1 , 2 , … , n , j = 1 , 2 , … , m ) \\ & 0 \leq {z}_{s t} \leq n\end{matrix} & ( 5 )\end{matrix}$$

For the optimal solution z* of the optimization problem shown in Expression (5), assuming that

$$\begin{matrix}[ Math . 12 ] & \\ {p}_{i}^{*} := - \frac{1}{{c}_{i}} \cdot {z}_{si} + \frac{{d}_{i}}{{c}_{i}} & \end{matrix}$$

it can be shown that (p*, z*) is the optimal solution of the optimization problem shown in Expression (4) above. Therefore, the solution can be obtained by solving the optimization problem shown in Expression (5) above.

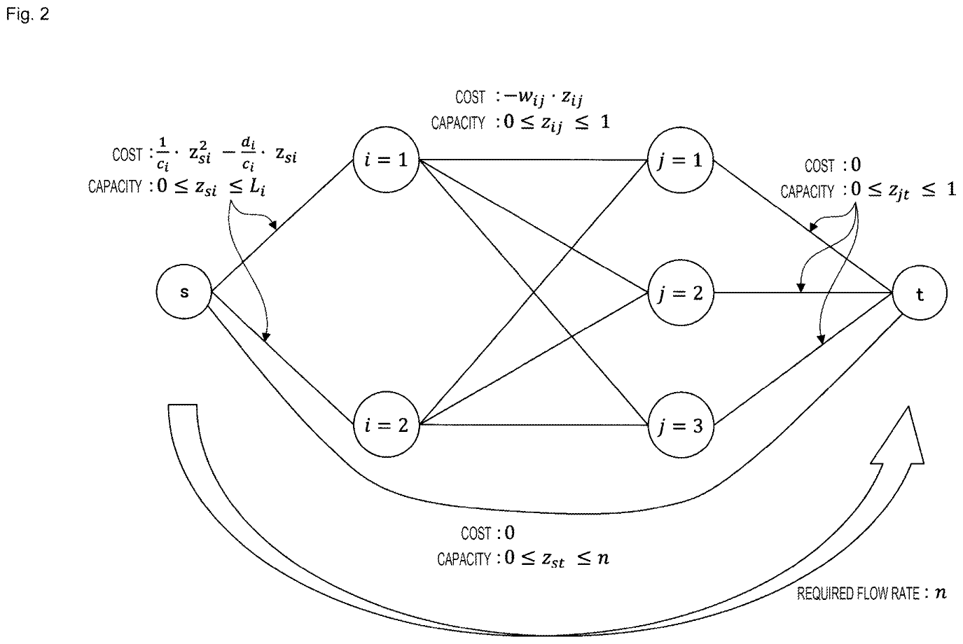

Since the optimization problem shown in Expression (5) is a minimum convex secondary cost flow problem, it can be solved at high speed using an existing solution. Note that the minimum convex secondary cost flow problem can be illustrated as a flow diagram on a network, and as an example, the minimum convex secondary cost flow problem shown in Expression (5) above when n=2 and m=3 is illustrated in FIG. 2.

Procedure 1-2b: Solution of Optimization Problem Shown in Expression (4) in a Case where the Acceptance Probability Sᵢ is Bijective and 1−Sᵢ is a Monotone Hazard Rate Function

When the following assumption is satisfied for probability Qᵢ(x):=1−Sᵢ(x), Qᵢ(x) is called a Monotone hazard rate function for x.

Assumption:

$$\begin{matrix}[ Math . 13 ] & \\ \frac{{Q}_{i}^{′} ( x )}{1 - {Q}_{i} ( x )} & \end{matrix}$$

is monotonically non-increasing with respect to x. Note that Qᵢ′(x) is a function (derivative) obtained by differentiating Qᵢ(x) with respect to x.

The above assumption is a relatively weak assumption including that Qᵢ is a normal distribution, a uniform distribution, a cumulative distribution function of an exponential distribution, or the like. Here, a case where the acceptance probability Sᵢ(x) is bijective and 1−Sᵢ(x) is a Monotone hazard rate function is considered.

First, since the first constraint condition of the optimization problem shown in Expression (4) above always satisfies the equality in a certain optimal solution p*,

pᵢ:=Sᵢ⁻¹(Σⱼzᵢⱼ) [Math. 14]

the following optimization problem is considered with the above setting.

$$\begin{matrix}[ Math . 15 ] & \\ \begin{matrix}{max}_{z} & {\sum }_{i} {S}_{i}^{- 1} ( {\sum }_{j} {z}_{ij} ) {\sum }_{j} {z}_{ij} + {\sum }_{ij} {w}_{ij} \cdot {z}_{ij} \\ s . t . & {\sum }_{j} {z}_{ij} ∈ X ( i = 1 , 2 , … , m ) \\ & {\sum }_{i} {z}_{ij} \leq 1 ( j = 1 , 2 , … , m ) \\ & 0 \leq {z}_{ij} \leq 1 ( i = 1 , 2 , … , n , j = 1 , 2 , … , m )\end{matrix} & \end{matrix}$$

where X is a domain of the function Sᵢ⁻¹. For the optimal solution z* of this optimization problem, with the following setting:

p*ᵢ:=Sᵢ⁻¹(Σⱼz*ᵢⱼ) [Math. 16]

(p*, z*) is the optimal solution of the optimization problem shown in Expression (4) above.

At this time, new subscripts s and t are prepared. It is assumed that for all i, zₛᵢ:=Σⱼzᵢⱼ, and for all j, zⱼₜ:=Σᵢzᵢⱼ. In addition, when zₛₜ is prepared as a slack variable, the above optimization problem can be rewritten as in the following Expression (6):

$$\begin{matrix}[ Math . 17 ] & \\ \begin{matrix}{min}_{p , z} & {\sum }_{i} - {S}_{i}^{- 1} ( {z}_{si} ) \cdot {z}_{si} - {\sum }_{ij} {w}_{ij} \cdot {z}_{ij} \\ s . t . & {\sum }_{i} {z}_{si} + {z}_{s t} = n , {\sum }_{j} {z}_{j t} + {z}_{s t} = n \\ & {z}_{si} - {\sum }_{j} {z}_{ij} = 0 ( i = 1 , 2 , … , n ) \\ & {\sum }_{i} {z}_{ij} - {z}_{j t} = 0 ( j = 1 , 2 , … , m ) \\ & {z}_{si} ∈ X ( i = 1 , 2 , … , n ) \\ & 0 \leq {z}_{j t} \leq 1 ( j = 1 , 2 , … , m ) \\ & 0 \leq {z}_{ij} \leq 1 ( i = 1 , 2 , … , n , j = 1 , 2 , … , m ) \\ & 0 \leq {z}_{s t} \leq n\end{matrix} & ( 6 )\end{matrix}$$

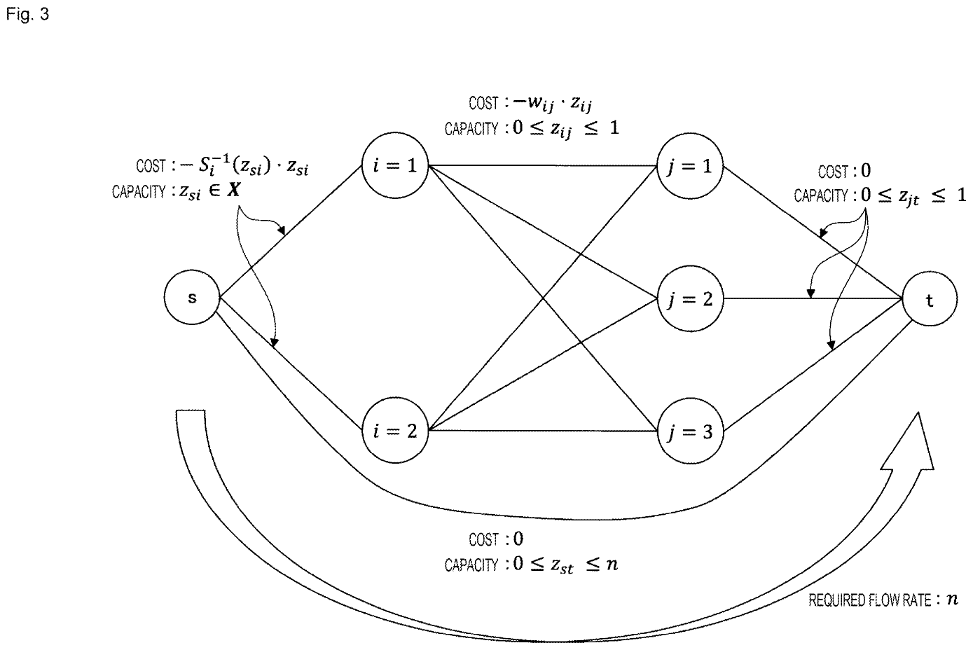

The optimization problem shown in Expression (6) is a capacity-constrained minimum cost flow problem. At this time, according to the above assumption, it can be shown that the objective function of the optimization problem shown in Expression (6) above is a convex function. Therefore, since the optimization problem shown in Expression (6) is a minimum convex cost flow problem, it can be solved at high speed using an existing solution. Note that the minimum convex cost flow problem can be illustrated as a flow diagram on a network, and as an example, the minimum convex cost flow problem shown in Expression (6) above when n=2 and m=3 is illustrated in FIG. 3.

Procedure 1-2c: Solution of Optimization Problem Shown in Expression (4) in a Case where the Acceptance Probability Sᵢ is Other

In a case where the acceptance probability Sᵢ is a general function that does not meet the conditions of 1-2a and 1-2b above, the optimization problem shown in Expression (4) above is a non-convex optimization problem. Therefore, by using a heuristic solution such as Bayesian optimization or simulated annealing, it is possible to obtain an optimal solution or an approximate solution of the optimization problem shown in Expression (4) above.

Note that, in the present embodiment, although a case where an optimal price for a participant is calculated in a crowdsourcing market that provides a service in the process of (a) to (c) described above has been described, the present invention is not limited thereto, and can be applied to any problem that can result in the optimization problem shown in Expression (2) above.

<Functional Configuration of Price Optimization Apparatus 10>

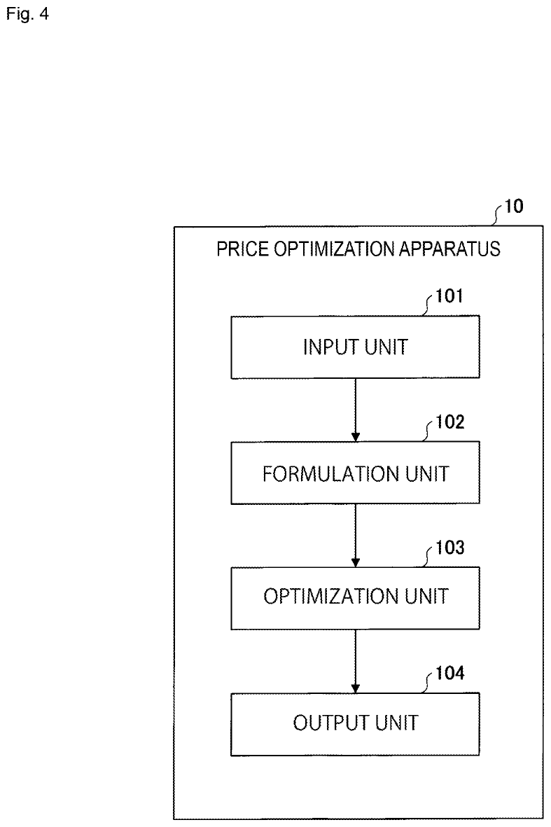

Next, a functional configuration of the price optimization apparatus 10 according to the present embodiment will be described with reference to FIG. 4. FIG. 4 is a diagram illustrating an example of a functional configuration of the price optimization apparatus 10 according to the present embodiment.

As illustrated in FIG. 4, the price optimization apparatus 10 according to the present embodiment includes an input unit 101, a formulation unit 102, an optimization unit 103, and an output unit 104.

The input unit 101 receives as input various parameters (the acceptance probability Sᵢ(x) and the value wᵢⱼ when the resource j is allocated to the participant i) given to the price optimization apparatus 10. Note that the input unit 101 may input these various parameters from any input source. For example, the input unit 101 may receive as input these various parameters by reading them from an auxiliary storage device or the like; may receive as input these various parameters by receiving them from another device or the like connected via a communication network or the like; or may receive as input these various parameters by receiving an input operation of a user or the like.

The formulation unit 102 formulates an optimization problem shown in Expression (2) above using various parameters input by the input unit 101.

The optimization unit 103 calculates an approximate solution of the optimization problem shown in Expression (2) formulated by the formulation unit 102. At this time, the optimization unit 103 transforms the optimization problem shown in Expression (2) into the optimization problem shown in Expression (4), and then, calculates an approximate solution by any of the procedures 1-2a, 1-2b, and 1-2c according to the feature of the acceptance probability Sᵢ(x). Note that, as described above, the solution of the optimization problem shown in Expression (4) is an approximate solution in which the degree of approximation of 3 is guaranteed for the optimization problem shown in Expression (2).

The output unit 104 outputs the approximate solution (that is, the price vector p having the price pᵢ for each participant i as an element) calculated by the optimization unit 103. Note that the output unit 104 may output the approximate solution to any output destination. For example, the output unit 104 may output (store) the approximate solution to an auxiliary storage device or the like; may output (transmit) the approximate solution to another device or the like connected via a communication network or the like; or may output (display) the approximate solution to a display device such as a display.

Note that, in the example illustrated in FIG. 4, a case where one price optimization apparatus 10 includes the respective functional units has been illustrated, but the present invention is not limited thereto, and a plurality of devices may include the respective functional units in a distributed manner. For example, there may be two devices of a formulation device and an optimization apparatus, the formulation device may include the formulation unit 102, and the optimization apparatus may include the optimization unit 103.

<Flow of Price Optimization Processing>

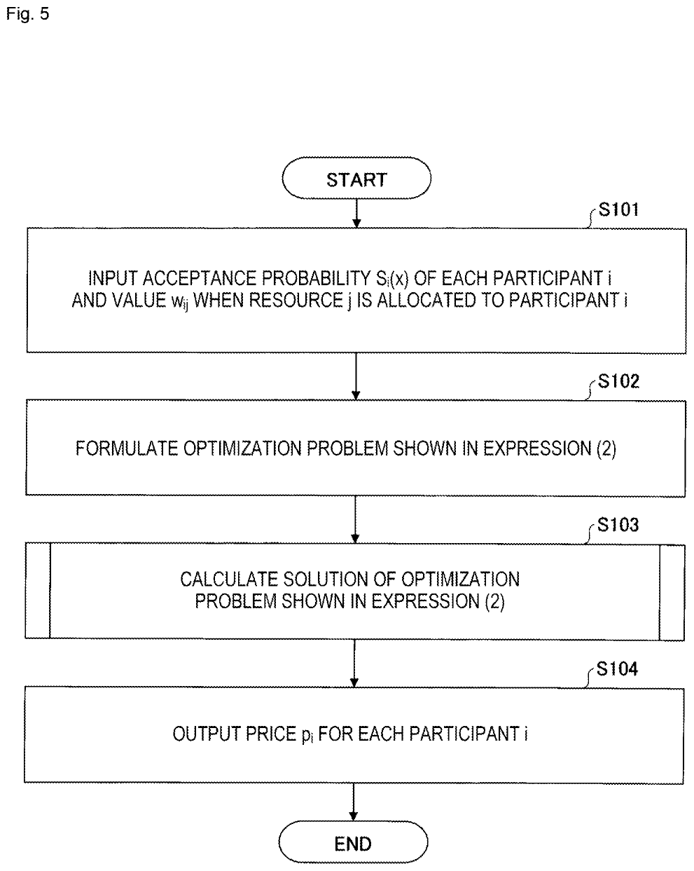

Next, a flow of price optimization processing executed by the price optimization apparatus 10 according to the present embodiment will be described with reference to FIG. 5. FIG. 5 is a flowchart illustrating an example of a flow of price optimization processing according to the present embodiment.

First, the input unit 101 receives as input various parameters (that is, the acceptance probability Sᵢ(x) and the value wᵢⱼ when the resource j is allocated to the participant i) given to the price optimization apparatus 10 (step S101).

Next, the formulation unit 102 formulates the optimization problem shown in Expression (2) above using the various parameters input in step S101 above (step S102).

Next, the optimization unit 103 calculates an approximate solution (an approximate solution in which a degree of approximation of 3 is guaranteed for the optimal solution) of the optimization problem shown in Expression (2) formulated in step S102 above (step S103). Details of the processing flow in step S103 will be described later.

Then, the output unit 104 outputs the approximate solution (that is, the price vector p having the price pᵢ for each participant i as an element) calculated in step S103 above (step S104).

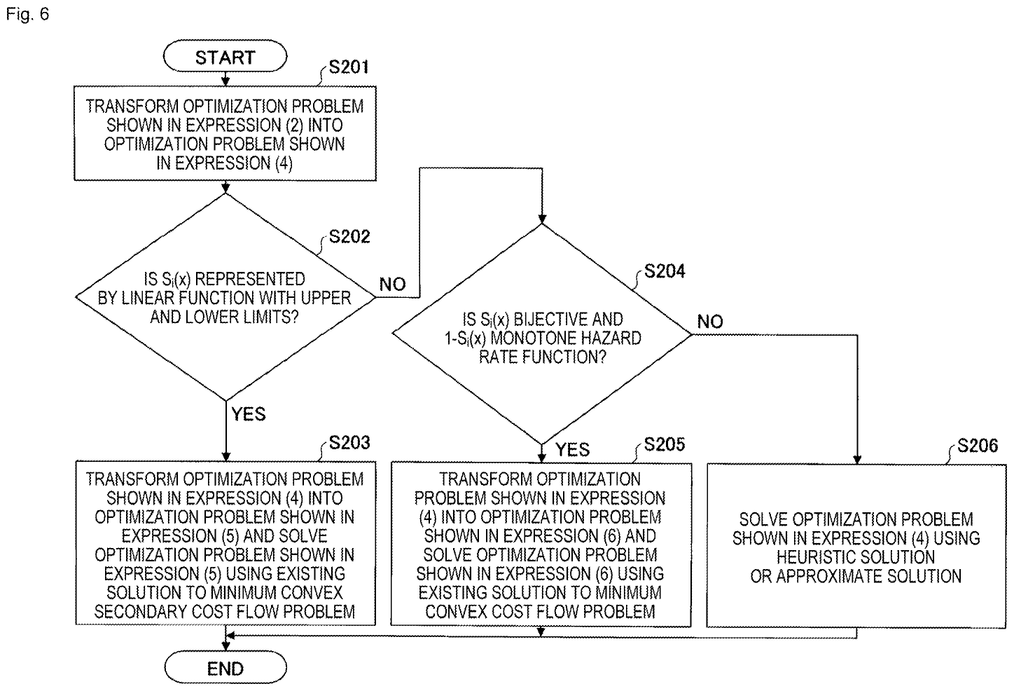

Here, the flow of the processing of calculating the approximate solution of the optimization problem shown in Expression (2) in step S103 above will be described with reference to FIG. 6. FIG. 6 is a flowchart illustrating an example of a flow of solution calculation processing of optimization problems according to the present embodiment.

First, the optimization unit 103 transforms the optimization problem shown in Expression (2) formulated in step S102 above into the optimization problem shown in Expression (4) above (step S201). That is, the optimization unit 103 transforms the optimization problem shown in Expression (2) into the optimization problem shown in Expression (4) by the above procedure 1-1.

Next, the optimization unit 103 determines whether or not the acceptance probability Sᵢ(x) input in step S101 above is represented by a linear function with upper and lower limits (step S202).

If it is determined in step S202 above that the acceptance probability Sᵢ(x) is represented by a linear function with upper and lower limits (YES in step S202), the optimization unit 103 calculates a solution by the above procedure 1-2a (step S203). That is, the optimization unit 103 transforms the optimization problem shown in Expression (4) into the optimization problem shown in Expression (5), and then, calculates the optimal solution of the optimization problem shown in Expression (5) using an existing solution to the minimum convex secondary cost flow problem.

On the other hand, if it is not determined in step S202 above that the acceptance probability Sᵢ(x) is represented by a linear function with upper and lower limits (NO in step S202), the optimization unit 103 determines whether or not the acceptance probability Sᵢ(x) is bijective and 1−Sᵢ(x) is a Monotone hazard rate function (step S204).

If it is determined in step S204 above that the acceptance probability Sᵢ(x) is bijective and 1−Sᵢ(x) is a Monotone hazard rate function (YES in step S204), the optimization unit 103 calculates a solution by the above procedure 1-2b (step S205). That is, the optimization unit 103 transforms the optimization problem shown in Expression (4) into the optimization problem shown in Expression (6), and then, calculates the optimal solution of the optimization problem shown in Expression (6) using an existing solution to the minimum convex cost flow problem.

On the other hand, if it is not determined in step S204 above that the acceptance probability Sᵢ(x) is bijective and 1−Sᵢ(x) is a Monotone hazard rate function (NO in step S204), the optimization unit 103 calculates a solution by the above procedure 1-2c (step S206). That is, the optimization unit 103 calculates an optimal solution or an approximate solution of the optimization problem shown in Expression (4) using a heuristic solution such as Bayesian optimization or simulated annealing.

As described above, the price optimization apparatus 10 according to the present embodiment can calculate and determine the optimal price by formulating the optimization problem in consideration of the matching value and the supply and demand balance for the crowdsourcing market that provides a service in the process of (a) to (c) described above and then solving the optimization problem. Moreover, the finally-obtained price (that is, the solutions calculated in steps S203, S205, and S206 above) is guaranteed to have a degree of approximation of 3 with respect to the optimal solution of the optimization problem formulated in consideration of the matching value and the supply and demand balance. Accordingly, for example, in the crowdsourcing market, it is possible to stably determine the price in consideration of compatibility between each task and each worker and the supply and demand balance.

<Hardware Configuration>

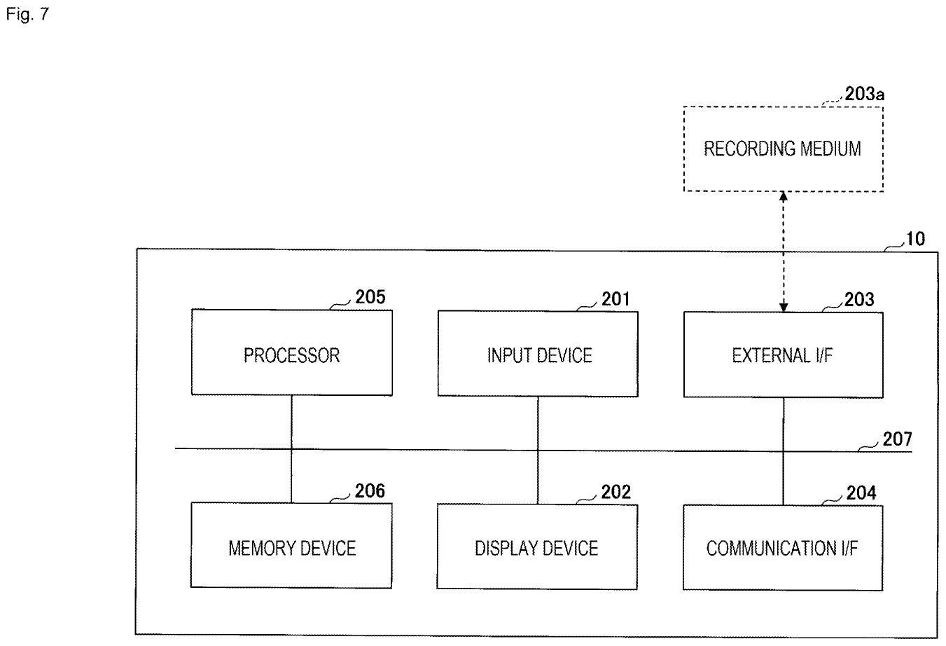

Finally, a hardware configuration of the price optimization apparatus 10 according to the present embodiment will be described with reference to FIG. 7. FIG. 7 is a diagram illustrating an example of a hardware configuration of the price optimization apparatus 10 according to the present embodiment.

As illustrated in FIG. 7, the price optimization apparatus 10 according to the present embodiment is implemented by a general computer or a computer system, and includes an input device 201, a display device 202, an external I/F 203, a communication I/F 204, a processor 205, and a memory device 206. These components of hardware are communicably connected via a bus 207.

The input device 201 is, for example, a keyboard, a mouse, a touch panel, or the like. The display device 202 is, for example, a display or the like. Note that the price optimization apparatus 10 may not include at least one of the input device 201 and the display device 202.

The external I/F 203 is an interface with an external device such as a recording medium 203a. The price optimization apparatus 10 can perform read, write, and the like on the recording medium 203a via the external I/F 203. For example, one or more programs for implementing the respective functional units (the input unit 101, the formulation unit 102, the optimization unit 103, and the output unit 104) included in the price optimization apparatus 10 may be stored in the recording medium 203a. Note that the recording medium 203a is, for example, a compact disc (CD), a digital versatile disk (DVD), a secure digital memory card (SD memory card), a universal serial bus (USB) memory card, or the like.

The communication I/F 204 is an interface for connecting the price optimization apparatus 10 to a communication network. Note that one or more programs for implementing each functional unit included in the price optimization apparatus 10 may be acquired (downloaded) from a predetermined server device or the like via the communication I/F 204.

The processor 205 is, for example, an arithmetic/logic device of various types such as a central processing unit (CPU) and a graphics processing unit (GPU). Each functional unit included in the price optimization apparatus 10 is implemented, for example, by processing in which one or more programs stored in the memory device 206 are executed by the processor 205.

The memory device 206 is, for example, a storage device of various types such as a hard disk drive (HDD), a solid state drive (SSD), a random access memory (RAM), a read only memory (ROM), and a flash memory.

The price optimization apparatus 10 according to the present embodiment can implement the above-described price optimization processing by having the hardware configuration illustrated in FIG. 7. Note that the hardware configuration illustrated in FIG. 7 is an example, and the price optimization apparatus 10 may have another hardware configuration. For example, the price optimization apparatus 10 may include a plurality of processors 205 or a plurality of memory devices 206.

The present invention is not limited to the above-mentioned specifically disclosed embodiment, and various modifications and changes, combinations with known technique, and the like can be made without departing from the scope of the claims.

### REFERENCE SIGNS LIST

10 Price optimization apparatus
101 Input unit
102 Formulation unit
103 Optimization unit
104 Output unit
201 Input device
202 Display device
203 External I/F
203a Recording medium
204 Communication I/F
205 Processor
206 Memory device
207 Bus

1. An optimization method executed by a computer including a memory and a processor, the optimization method comprising:
receiving as input an acceptance probability function indicating a probability that each participant participating in a crowdsourcing market accepts a price, and a matching value indicating a value when each resource in the crowdsourcing market is allocated to each participant;
formulating a first optimization problem for determining an optimal price that maximizes a profit of a provider of the crowdsourcing market using the acceptance probability function and the matching value; and
calculating the optimal price by solving the first optimization problem according to a feature of the acceptance probability function.

2. The optimization method according to claim 1, wherein in the optimization procedure, the optimal price is calculated by transforming the first optimization problem into a second optimization problem using an approximate value of an objective function of the first optimization problem and solving the second optimization problem.

3. The optimization method according to claim 2, wherein an optimal solution of the second optimization problem is a solution in which a degree of approximation of 3 is guaranteed for an optimal solution of the first optimization problem.

4. The optimization method according to claim 2, wherein denoting an index representing each of the participants as i, a variable representing the price as x, and an acceptance probability function of the participant i as Si(x),
in the optimization procedure, when the acceptance probability function Si(x) is represented by a linear function with upper and lower limits, the optimal price is calculated by transforming the second optimization problem into a minimum convex secondary cost flow problem and solving the minimum convex secondary cost flow problem, and
when the acceptance probability function Si(x) is bijective and each function represented by 1−Si(x) is a Monotone hazard rate function, the optimal price is calculated by transforming the second optimization problem into a minimum convex cost flow problem and solving the minimum convex cost flow problem.

5. The optimization method according to claim 4, wherein in the optimization procedure, when the acceptance probability function Si(x) is not represented by a linear function with upper and lower limits and the acceptance probability function Si(x) is not bijective or each function represented by 1−Si(x) is not a Monotone hazard rate function, the optimal price is calculated by solving the second optimization problem using a heuristic solution including Bayesian optimization and simulated annealing.

6. An optimization apparatus comprising:
a memory; and
a processor configured to
receive as input an acceptance probability function indicating a probability that each participant participating in a crowdsourcing market will accept a price, and a matching value indicating a value when each resource in the crowdsourcing market is allocated to each participant;
formulate a first optimization problem for determining an optimal price that maximizes a profit of a provider of the crowdsourcing market using the acceptance probability function and the matching value; and
calculate the optimal price by solving the first optimization problem according to a feature of the acceptance probability function.

7. A non-transitory computer-readable recording medium having computer-readable instructions stored thereon, which when executed, cause a computer to execute the optimization method according to claim 1.
